(19) United States
(12) Patent Application Publication
(10) Pub. No.: US 2024/0314157 A1
(43) Pub. Date: Sep. 19, 2024

(54) COMPARING EVENT PROFILE FOR TARGET SYSTEM EVENT-PROCESSING DATA SOURCE TO REFERENCE EVENT PROFILE

(71) Applicant: MICRO FOCUS LLC, Santa Clara, CA (US)

(72) Inventors: Martin Fraser Arlitt, Calgary (CA); Manish Marwah, Santa Clara, CA (US)

(21) Appl. No.: 18/123,265

(22) Filed: Mar. 18, 2023

(51) Int. Cl. H04L 9/40

(52) U.S. Cl. CPC H04L 63/1433; H04L 63/1416; H04L 63/1425

(57) ABSTRACT

An event profile corresponding to a data source at a target system is determined. The event profile includes, for each of a number of fields, a percentage of events that after processing by the data source include data in that event field. A reference event profile is determined that includes, for each of the event fields, a reference percentage. The event profile is compared to the reference event profile. Whether the data source properly processed the events is determined based on comparison of the event profile to the reference event profile.

### BACKGROUND

A significant if not the vast majority of computing devices are globally connected to one another via the Internet. While such interconnectedness has resulted in services and functionality almost unimaginable in the pre-Internet world, not all the effects of the Internet have been positive. A downside, for instance, to having a computing device potentially reachable from nearly any other device around the world is the computing device's susceptibility to malicious cyberattacks that likewise were unimaginable decades ago.

### BRIEF DESCRIPTION OF THE DRAWINGS

FIG. 1 is a diagram of an example target system in which raw events received from devices are processed by data sources for subsequent analysis by content.

FIG. 2 is a flowchart of an example method for determining whether a data source properly processed raw events received from devices for subsequent analysis by content, and reconfiguring the target system if the data source did not properly process the raw events.

FIG. 3A is a diagram of example processed events that may or may not have data in different event fields, and FIG. 3B is a diagram of an example event profile generated based on the example events.

FIGS. 4A and 4B are diagrams of different example reference event profiles to which an event profile generated based on processed events can be compared to determine whether a data source properly processed the raw events when generating the processed events.

FIGS. 5A, 5B, and 5C are diagrams of example presence-level, aggregate-level, and distribution-level comparisons, respectively, between an event profile and a reference event profile.

FIGS. 6A and 6B are flowcharts of different example methods depicting how a provider system and one or more target systems can interact with one another to perform the method of FIG. 2.

FIG. 7 is a diagram of an example non-transitory computer-readable data storage medium.

FIG. 8 is a diagram of an example provider system communicatively connected to target systems.

### DETAILED DESCRIPTION

As noted in the background, a large percentage of the world's computing devices can communicate with one another over the Internet, which is generally advantageous. Computing devices like servers, for example, can provide diverse services, including email, remote computing device access, electronic commerce, financial account access, and so on. However, providing such a service can expose a server computing device to cyberattacks, particularly if the software underlying the services has security vulnerabilities that a nefarious party can leverage to cause the application to perform unintended functionality and/or to access the underlying server computing device.

Individual servers and other devices of a target system, including network devices (e.g., firewalls and routers) and computing devices other than server computing devices, may output events, such as log entries, indicating status and other information regarding their hardware, software, and communication. Such communication can include intra-and inter-device communication as well as intra-network (i.e., between devices on the same network) and inter-network (i.e., between devices on different networks, such as devices connected to one another over the Internet) communication.

The terminology event is used generally herein, and encompasses all types of data that such devices may output. For example, such data that is encompassed under the rubric of events includes that which may be referred to as messages in addition to log events, as well as that which may be stored in databases or files of various formats. Moreover, the events as or when output by the devices are specifically referred to as raw events.

To detect potential security vulnerabilities and potential cyberattacks by nefarious parties, voluminous amounts of data in the form of such raw events may therefore be collected, and then analyzed in an offline or online manner to identify such security issues. Raw events may further provide information regarding issues unrelated to security, such as operational issues and business activities. For example, such operational issues can include operational inefficiencies that can be identified in order to improve operational performance. As another example, the raw events can be used to derive system characteristics that may provide information and insights for the future design of systems and applications.

An enterprise or other large organization may have a large number of servers and other devices, within one or multiple target systems, which output raw events. The raw events output by devices of a target system may be consolidated so that they can be analyzed en masse. Some security and other issues, for instance, may be more easily detected or may only be able to be detected by analyzing interrelationships among the raw events collected by multiple devices of a target system. Analyzing the raw events of just one computing device of a target system may not permit such security or other issues to be detected.

The architecture in which raw events are collected for analysis may include multiple data sources and content. Each data source receives raw events from devices within a target system that are of a corresponding type, and processes the raw events to generate processed events, which may be referred to as normalized events, in the format expected by content. Each raw event can be converted to a corresponding processed event. The content then analyzes the processed events to identify whether the events are indicative of security vulnerabilities or other types of anomalies at the target system. Examples of content can include rules, filters, lookup lists, logic, tools, utilities, and so on, of application programs that identify whether a target system has a security issue or other anomaly (e.g., whether the target system is exhibiting anomalous behavior).

The format in which different types of devices of a target system output raw events may differ. So that the content is able to perform analysis on such heterogenous events, for each different device type (or each different format in which devices output raw events) there is a data source that processes (e.g., normalizes or converts) the raw events output by devices into the format expected by the content. A data source thus receives raw events from devices and outputs respective processed events to content.

For content to properly analyze processed events to identify whether the events are indicative of an anomaly such as a security vulnerability, different event fields of the processed events may have to be populated with data. There may be tens, hundreds, or even thousands of different event fields. Particular content may just use data in a subset of all the possible event fields when performing anomaly analysis, regardless of whether the processed events are populated with data for event fields other than this subset.

However, when generating processed events from raw events received from devices, if a data source does not populate the event fields that the content needs to be populated for performing anomaly analysis, the content may fail to identify an anomaly even when one exists in the target system. The data source may not populate the event fields that the content expects to be populated because it is misconfigured, for instance. As another example, the data source may be an older version as compared to the version of the content (or vice versa), and therefore may not populate the expected event fields with data when generating the processed events.

Techniques described herein identify whether data sources are properly processing events so that the subsequent anomaly analysis performed by content is accurate. That is, the described techniques can identify whether, when generating processed events from raw events received from devices, a data source is populating the event fields with data that the content is expecting to be populated with data so that the content can accurately perform anomaly analysis.

In making this identification, the techniques do not have to take into account the actual data values populated in any event field. That is, the described techniques can just concern whether processed events generated by a data source have data within certain event fields, and not what that data is. So long as a data source is processing raw events received from devices of a target system to generate processed events that are populated with data in the event fields that the content expects to be populated, the data source can be considered as properly processing the raw events, regardless of the actual data populated in the event fields.

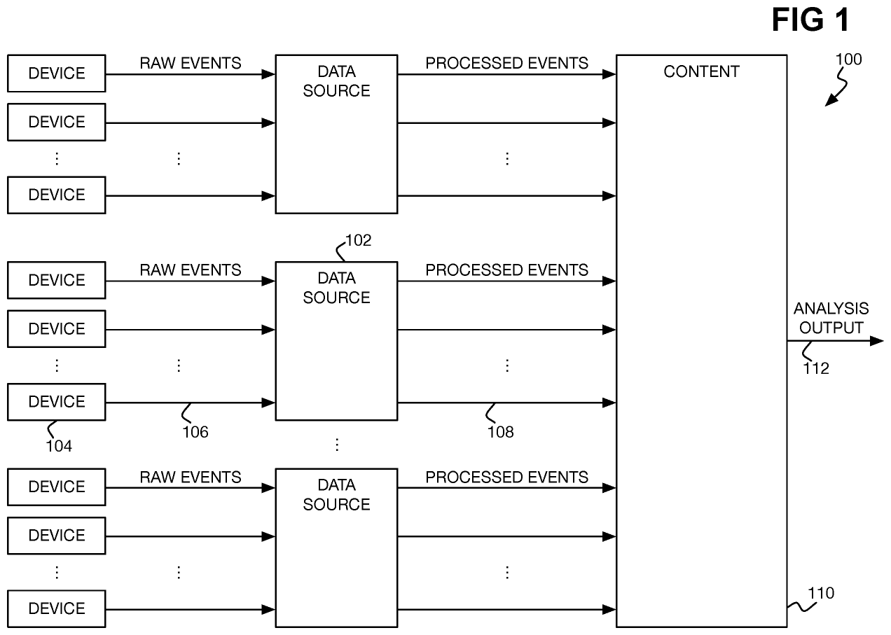

FIG. 1 shows an example target system 100. The target system 100 is a computing system in relation to which whether an anomaly is present is to be determined. The target system 100 includes one or multiple data sources 102 that each receive raw events 106 from devices 104 of a corresponding type. The devices 104 from which a data source 102 receives raw events 106 are of the same type at least in that the devices 104 output raw events 106, such as log entries, in a particular format or formats understood by the data source 102. Therefore, each data source 102 may correspond to a different format of raw events 106.

An example of a data source 102 is a connector used in the ArcSight Enterprise Security Manager (ESM) security information and event management (SEIM) platform, available from OpenText Corp. of Waterloo, Canada. ArcSight connectors normalize raw events 106 into a unified format known as the Common Event Format (CEF). A given ArcSight connector therefore may be configured to convert raw events 106 in a particular format into the CEF. The CEF is a standard for the interoperability of event-or log-generating devices and applications, and defines a syntax for log records.

The data sources 102 therefore generate processed events 108 from the raw events 106 received from the devices 104. For each raw event 106 that a data source 102 receives, the data source 102 converts the raw event 106 into a processed event 108. In the case of the CEF, among other processed event formats, there may be a large number of event fields, only certain of which may be populated by the data source 102 for a given type of raw event 106 when generating the processed event 108.

The target system 100 also includes content 110. The content 110 receives the processed events 108 from the data sources 102, and performs an anomaly analysis on the processed events 108 to identify whether there is an anomaly, such as a security vulnerability, within the target system 100 (e.g., the devices 104 thereof). The content 110 outputs an analysis output 112 in this respect. Because the processed events 108 are in a common format like the CEF, the content 110 does not have to be aware of the various format types in which the devices 104 output the raw events 106.

In the depicted example, there is one content 110, but there may be more than one content 110. The content 110 may be considered as the rules, filters, lookup lists, logic, tools, utilities, and so on, of application programs that identify whether the target system 100 is anomalous (e.g., whether the target system 100 is exhibiting anomalous behavior). For example, the ArcSight ESM SEIM platform provides an ArcSight Activate Framework in which different types of content 110 can be installed or developed to analyze processed events 108 to identify an anomaly.

To properly (e.g., accurately) analyze the processed events 108, the content 110 may expect that the processed events 108 are populated with data in certain event fields. When converting the raw events 106, the data sources 102 may populate the processed events 108 with data in more event fields than is necessary for the content 110 to perform accurate analysis. The content 110 may thus not consider data of processed events 108 in some event fields.

The event fields that the content 110 does consider when performing anomaly analysis should be populated with data in the processed events 108, though. Otherwise, the analysis accuracy of the content 110 may suffer. For example, the content 110 may indicate, based on the processed events 108 generated from the raw events 106 output by the devices 104, that there is no anomaly in the target system 100 when in actuality there is. The analysis output 112 from the content 110 may thus be accurate to the extent that the processed events 108 have data in event fields that the content 110 expects to have data.

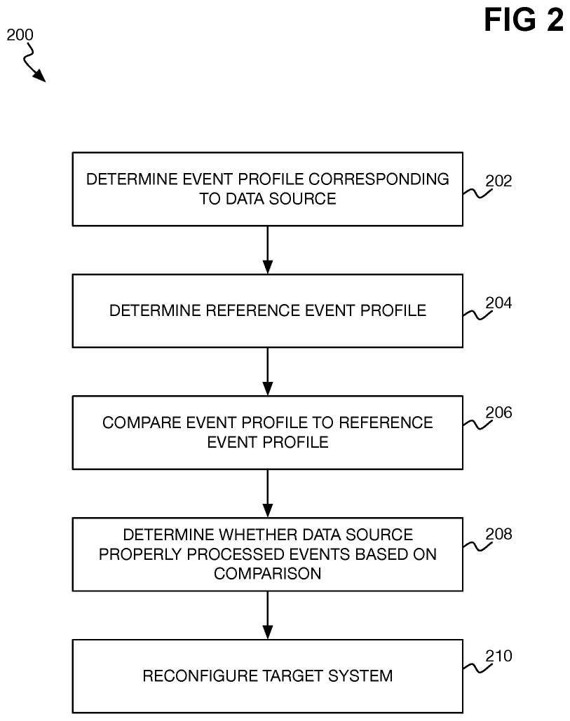

FIG. 2 shows an example method 200 for determining whether a given data source 102 properly processed raw events 106 when generating the processed events 108. For instance, the method 200 can determine whether, when generating the processed events 108 from the raw events 106, the data source 102 populated with data the event fields that the content 110 expects to be populated in order to perform an accurate anomaly analysis. The method 200 can be implemented as program code stored on a memory or other non-transitory computer-readable data storage medium, and which is executed by a processor.

The method 200 includes determining an event profile corresponding to the data source 102 in question (202). The event profile includes, for each of the event fields of the common format (e.g., the CEF) of the processed events 108 generated by the data source 102 from the raw events 106, the percentage of the processed events 108 that include data in the event field. As noted, a data source 102 may not populate every event field with data when generating a processed event 108 from a raw event 106. The event profile further does not have to reflect the actual values of data of the raw events 106 for any event field. Rather, the event profile may reflect, for each event field, just the percentage of the raw events 106 that include data, regardless of what the values of that data actually are.

The method 200 includes determining a reference event profile (204). The reference profile includes a reference percentage for each event field of the common format (e.g., the CEF). In one implementation, the reference profile can explicitly denote the event fields that the content 110 expects to be populated with data in the processed events 108 for accurate analysis of the processed events 108. In this case, the reference percentage for each event field may be 100%, indicating that the content 110 expects the event field to be populated with data, or 0%, indicating that the content 110 does not expect the event field to be populated with data or that the content 110 does not use the event field in question when performing analysis of the processed events 108.

In another implementation, the reference profile may implicitly denote the event fields that the content 110 uses when analyzing the processed events 108. For example, there may be a number or group of data sources 102 that may or may not include the data source 102 for which an event profile has been determined. These data sources 102 are of the same data source type as one another (and the same type as the data source 102 for which an event profile has been determined) insofar as they all generate processed events 108 input to the same content 110 for performing anomaly analysis.

In this case, it may be assumed that the majority—if not the vast majority—of the group of data sources 102 properly process raw events 106 received from devices 104 when generating the processed events 108. That is, it may be assumed that most if not more or all of the data sources 102 populate the processed events 108 with data in the event fields that the content 110 expects to be populated. The reference percentage for each event field in this case is therefore the percentage of the processed events 108 generated by the group of data sources 102 that are populated with data in the event field in question. The reference percentage for an event field in this implementation can thus vary between 0% and 100%.

The method 200 includes comparing the event profile to the reference profile (206). The result of the comparison is a value indicative of how similar the event profile is to the reference profile. The comparison may be a presence-level, aggregate-level, or distribution-level comparison. In a presence-level comparison, whether more than a threshold percentage of the processed events 108 generated by the data source 102 have been populated with data in each event field (as specified by the event profile) is compared with whether the content 110 expects that event field to be populated with data (as specified by the reference profile).

In an aggregate-level comparison, the percentage of the processed events generated by the data source 102 have been populated with data for each field (as specified by the event field) is compared with the corresponding reference percentage in the reference event profile. In a distribution-level comparison, the distribution over time (e.g., a given day, week, and so on) as to the percentage of the processed events generated by the data source 102 (as specified by the event profile) that have been populated with data in each event field is compared with the (reference) distribution over time as to the reference percentage for each event filed in the reference profile. The distribution and the reference distribution for a given event field may instead be over a variable related to that event field, instead of over time, such as value type (e.g., whether the values are discrete value types of continues value types), and so on.

The method 200 includes determining whether the data source 102 properly processed the raw events 106 when generating the processed events 108, based on the comparison (208). For example, the comparison result value may be compared to a threshold. Assuming that higher values are indicative of greater similarity of the event profile to the reference event profile, if the value is greater than a threshold, then the data source 102 is identified as having properly generated the processed events 108. That is, the data source 102 is identified as having sufficiently populated the processed events 108 with data in the event fields that the content 110 expects to be populated with data.

However, again assuming that higher values are indicative of greater similarity of the event profile to the reference event profile, if the comparison result value is less than the threshold, then the data source is identified as not having properly generated the processed events 108. That is, the data source 102 is identified as having insufficiently populated the processed events 108 with data in the event fields that the content 110 expects to be populated with data. In this case, the content 110 may not accurately analyze the processed events 108 in identifying whether there is an anomaly within the target system 100.

In response to determining that the data source 102 has not properly generated the processed events 108 from the raw events 106, the method 200 can include reconfiguring the target system 100 so that it properly converts raw events 106 into processed events 108 in the future (210). For example, the data source 102 may be updated to a newer version that does properly process the raw events 106. Other actions may also be performed in this respect so that the content 110 accurately identifies anomalies when analyzing the processing the processed events 108. For example, the provider of the content 110 may modify the content 110 so that it does not have to use the event fields that the data source 102 does not populate in the processed events 108.

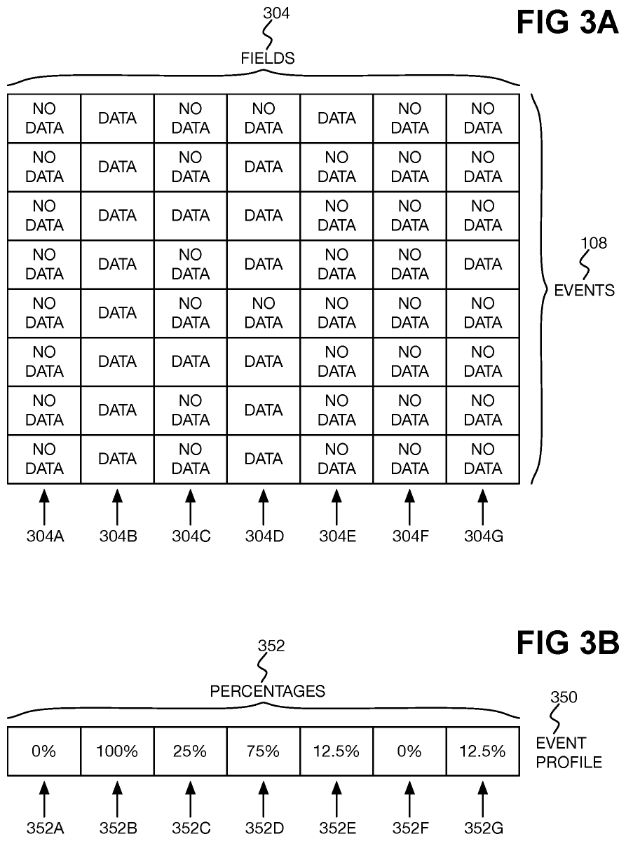

FIG. 3A shows example processed events 108 generated by a data source 102 from raw events 106 received from devices 104, on which basis an event profile may be generated in the method 200. Eight example processed events 108 are depicted, but in actuality there are likely to be thousands, tens of thousands, or more of such processed events 108. It is noted that the number of processed events 108 that are considered are those occurring within a given time interval, where each such time interval is separately considered, and where the time intervals may be uniform or non-uniform. Furthermore, the processed events 108 may be the result of aggregation of multiple events. The processed events 108 may or may not each include data for each event field 304A, 304B, 304C, 304D, 304E, 304F, and 304G, which are collectively referred to as the event fields 304. Seven example event fields 304 are depicted, but in actuality there are likely to be tens or hundreds, if not more, of such event fields 304.

If a processed event 108 has data in a given event field 304, the figure denotes “data.” The processed event 108 for such an event field 304 will in actuality include a particular value for such data, such as a numeric, text, or Boolean value. However, the actual value of the data does not need to be used in generating the event profile in the method 200, and therefore is not shown in the figure. Similarly, if a processed event 108 does not have data in a given event field 304, the figure denotes “no data.”

FIG. 3B shows an example event profile 350 generated from the processed events 108 of FIG. 3A. The event profile 350 has percentages 352A, 352B, 352C, 352D, 352E, 352F, and 352G, which are collectively referred to as the percentages 352, and which respectively correspond to the event fields 304. For each event field 304, the corresponding percentage 352 is equal to the percentage of the processed events 108 that have data in that event field 304, regardless of the actual value of that data. For example, none of the processed events 108 have data in the event field 304A, such that the percentage 352A is 0%. As another example, six of the eight processed events 108 have data in the event field 304D, such that the percentage 352D is 6/8=75%.

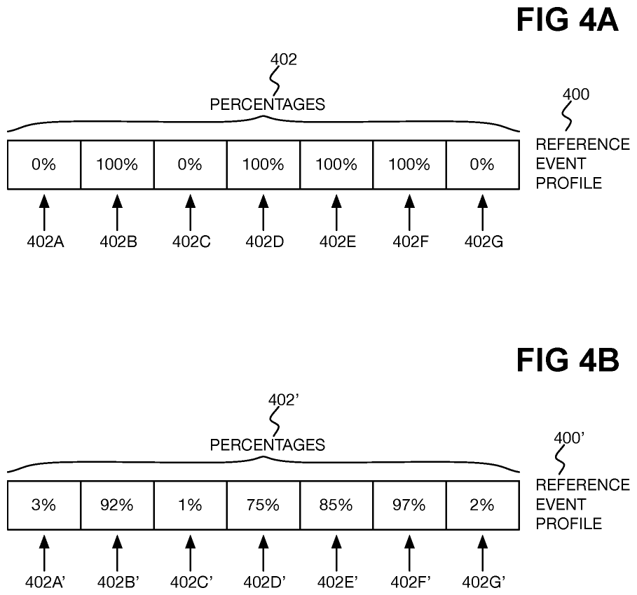

FIGS. 4A and 4B respectively show example reference event profiles 400 and 400′. The reference event profile 400 of FIG. 4A has reference percentages 402A, 402B, 402C, 402D, 402E, 402F, and 402G, which are collectively referred to as the reference percentages 402, and which respectively correspond to the event fields 304. Each reference percentage 402 is set to 100% if the content 110 expects the corresponding event field 304 to be populated with data, and is set to 0% if the content 110 does not expect the corresponding event field 304 to be populated with data.

That is, the corresponding reference percentage 402 is set to 100% if the content 110 uses the corresponding event field 304 when analyzing the processed events 108 to perform anomaly analysis. The corresponding reference percentage 402 is similarly set to 0% if the content 110 does not use the corresponding event field 304 when analyzing the processed events 108 to perform anomaly analysis. The reference event profile 400 thus explicitly indicates the event fields 304 that the content 110 uses to perform anomaly analysis, and may be manually specified by the developer or provider of the content 110.

The reference event profile 400′ of FIG. 4B likewise has reference percentages 402A′, 402B′, 402C′, 402D′, 402E′, 402F′, and 402G′, which are collectively referred to as the reference percentages 402′, and which respectively correspond to the event fields 304. Unlike the reference percentages 402, the reference percentages 402′ are not each 100% or 0%. This is because the reference event profile 400′ may just implicitly indicate the event fields 304 that the content 110 uses to perform anomaly analysis, and may be automatically generated instead of being manually specified by the developer or profile of the content 110.

For instance, the reference event profile 400′ may be generated in a similar manner as the event profile 350, but from the processed events 108 of a group of data sources 102 (that may or may not include the data source 102 to which the event profile 350 corresponds) that output processed events 108 to the same content 110 or to the same type of content 110. Therefore, the corresponding reference percentage 402′ for each event field 304 is the percentage of the processed events 108 generated by the data sources 102 of the group that have data for the event field 304 in question.

It may be presumed that the majority if not the vast majority of the data sources 102 of the group populate the processed events 108 with data in the event fields 304 that the content 110 expects to be populated with data. The reference event profile 400′ may be considered an approximation of the reference event profile 400, but does not require manual specification as may be required with the reference event profile 400. For instance, for each event field 304 for which the corresponding reference percentage 402 is 100% in the reference event profile 400, the corresponding reference percentage 402′ in the reference event profile 400′ is no less than 75% in the depicted example. For each event field 304 for which the corresponding reference percentage 402 is 0%, the corresponding reference percentage 402′ is no more than 3% in the depicted example.

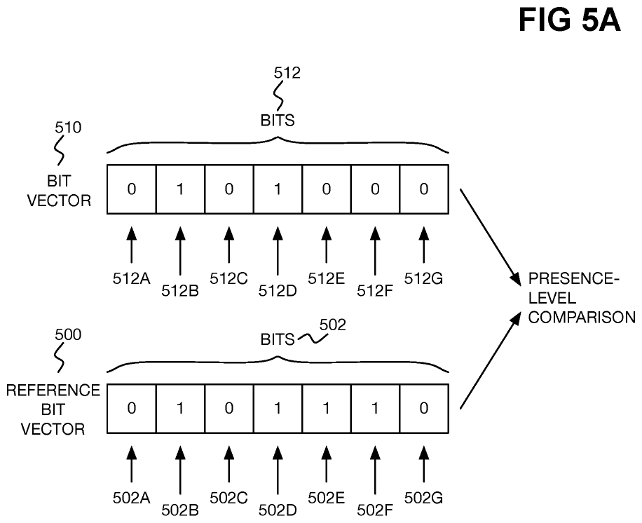

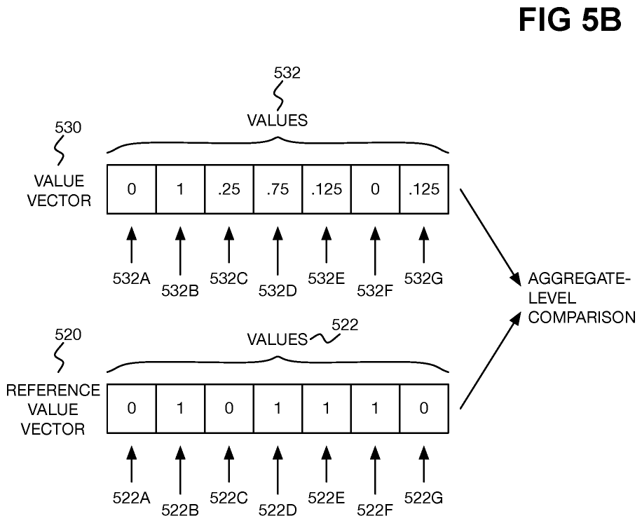

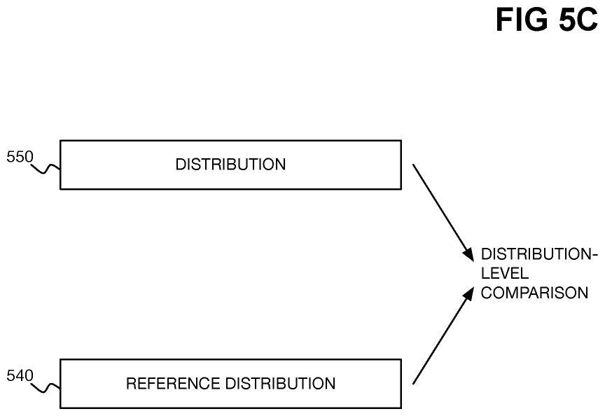

FIG. 5A shows an example presence-level comparison between the event profile 350 and the reference event profile 400. (A presence-level comparison can similarly be made between the event profile 350 and the reference event profile 400′.) A reference bit vector 500 is generated from the reference event profile 400, and has bits 502A, 502B, 502C, 502D, 502E, 502F, and 502G, collectively referred to as the bits 502 and respectively corresponding to the event fields 304. A bit vector 510 is similarly generated from the event profile 350, and has bits 512A, 512B, 512C, 512D, 512E, 512F, and 512G, collectively referred to as the bits 512 and also respectively corresponding to the event fields 304.

A bit 502 of the reference bit vector 500 is set to 1 if the reference percentage 402 of the reference event profile 400 for the corresponding event field 304 is greater than a threshold (e.g., 70%). A bit 502 is set to 0 if the reference percentage 402 for the corresponding event field 304 is less than the threshold. Similarly, a bit 512 of the bit vector 510 is set to 1 if the percentage 352 of the event profile 350 for the corresponding event field 304 is greater than the threshold. A bit 512 is similarly set to 0 if the percentage 352 for the corresponding event field 304 is less than the threshold. The actual values of the percentages 352 and 402 are therefore not encoded in the bit vectors 510 and 500, just whether they are greater or less than the threshold.

The event profile 350 is compared in a presence-level manner to the reference event profile 400 by calculating a similarity measure between the bit vector 510 of the event profile 350 and the reference bit vector 500 of the reference event profile 400. As one example, the similarity measure may be calculated as the Jaccard similarity. Therefore, the bits 502 and 512 that are 0 are ignored, and just the bits 502 and 512 that are 1 are considered. The resulting similarity measure is indicative of the extent to which the processed events 108 from which the event profile 350 was generated are populated with data in event fields 304 specified by the reference event profile 400.

FIG. 5B shows an example aggregate-level comparison between the event profile 350 and the reference event profile 400. (An aggregate-level comparison can similarly be made between the event profile 350 and the reference event profile 400′.) A reference value vector 520 is generated from the reference event profile 400, and has values 522A, 522B, 522C, 522D, 522E, 522F, and 522G, collectively referred to as the values 522 and respectively corresponding to the event fields 304. A value vector 530 is similarly generated from the event profile 350, and has values 532A, 532B, 532C, 532D, 532E, 532F, and 532G, collectively referred to as the values 532 and respectively corresponding to the event fields 304.

Each value 522 of the refence value vector 520 is set to the reference percentage 402 of the reference event profile 400 for the corresponding event field 304. For example, the value 522A is 0 in correspondence with the reference percentage 402A being 0%, and the value 522B is 1 in correspondence with the referenced percentage 402B being 100%. Each value 532 of the value vector 530 is set to the percentage 352 of the event profile 350 for the corresponding event field 304. For example, the value 532D is 0.75 in correspondence with the percentage 352D being 75%, and the value 532E is 0.125 in correspondence with the percentage 352E being 12.5%. The actual values of the percentages 352 and 402 are therefore encoded in the value vectors 520 and 530, in contradistinction their encoding in the bit vectors 510 and 500.

The event profile 350 is compared in an aggregate-level manner to the reference event profile 400 by calculating a similarity measure between the value vector 530 of the event profile 350 and the reference value vector 520 of the reference event profile 400. As one example, the similarity measure may be calculated as the cosine similarity. Therefore, value vectors 530 and 520 with similar proportions of values 532 and 522 but with different values 532 and 522 are still indicated as being similar. The resulting similarity measure is indicative of the extent to which the processed events 108 from which the event profile 350 was generated are populated with data in event fields 304 specified by the reference event profile 400.

FIG. 5C shows an example distribution-level comparison between the event profile 350 and the reference event profile 400. (A distribution-level comparison can similarly be made between the event profile 350 and the reference event profile 400′.) A reference distribution 540 over time (or another variable related to a given event field 304, as noted above) as to the reference percentage 402 of the reference event profile 400 is calculated for each event field 304. The reference distribution 540 is a probability distribution that identifies patterns in the reference percentage 402 over time for an event field 304. A distribution 550 over time (or another variable) as to the percentage 352 of the event profile 350 for each event field 304 is similarly calculated. The distribution 550 is a probability distribution that identifies patterns in the percentages 352 over time for an event field 304. The distributions 540 and 550 for an event field 304 may each be in the form of a vector or tensor.

The event profile 350 is compared in a distribution-level manner to the reference event profile 400 by calculating a similarity measure between the distribution 550 of the event profile 350 and the reference distribution 540 of the reference event profile 400. For example, a forward information-theoretic measure of the distance from the reference distribution 540 to the distribution 550 and a reverse information-theoretic measure of the distance from the distribution 550 to the reference distribution 540 may be calculated. An example of such an information-theoretic measure is KL-divergence, which is zero for identical distributions, and positive with no upper bound for dissimilar distributions.

The forward and reverse KL-divergences are not symmetric. The forward KL-distribution is high at high regions of the reference distribution 540. However, large differences between the reference distribution 540 and the distribution 550 where the reference distribution 540 is low is not well reflected in the forward KL-distribution. Therefore, the reverse KL-divergence is used to account for regions where the reference distribution 540 is low but the distribution 550 is high.

When the distribution 550 matches the reference distribution 550, both the forward and reverse KL-divergences are low. When the distribution 550 is identical to the reference distribution 550, the forward and reverse KL-divergences are zero. However, KL-divergence is unbounded, which can reduce its usefulness as a measure to compare whether the distribution 550 sufficiently matches the reference distribution 540. Furthermore, KL-divergence is a distance measure, and is not a similarity measure per se.

Therefore, a bounded forward similarity measure and a bounded reverse similarity measure can be calculated from their respective forward and reverse KL-divergences. The bounded forward and reverse similarity measures can then be combined into a single metric. The similarity of the distributions 540 and 550 are indicated by this metric. The metric is indicative of the extent to which the processed events 108 from which the event profile 350 was generated are populated with data in event fields 304 specified by the reference event profile 400.

The generation of the event profile 350 and of the reference event profile 400′ in particular, followed by the resulting comparison of the event profiles 350 and 400′ and the determination as to whether the data source 102 properly processed raw events 106 based on this comparison, can be performed at the target system 100. That is, if the target system 100 includes a sufficient number of data sources 102 that output processed events 108 to the same content 110, the reference event profile 400′ can be generated from the processed events 108 generated by these data sources 102. In another implementation, the reference event profile 400 (as opposed to the event profile 400′) may be generated at the target system 100. This may particularly be the case if the entity operating the target system 100 (or on whose behalf the target system 100 is being operated) developed their own data sources 102 and/or content 110, or customized or otherwise modified data sources 102 and/or content 110 supplied by a provider (e.g., the developer of the data sources 102 and/or content 110).

An event profile 350 can then be generated from the processed events 108 generated by any of these data sources 102 (or another data source 102 outputting processed events 108 to the content 110 in question). The comparison of the event profile 350 for such a data source 102 to the reference event profile 400′ therefore is indicative of whether the data source 102 properly generated its processed events 108 (that is, whether the data source 102 populated processed events 108 with data in the event fields 304 that the other data sources 102 populated with data).

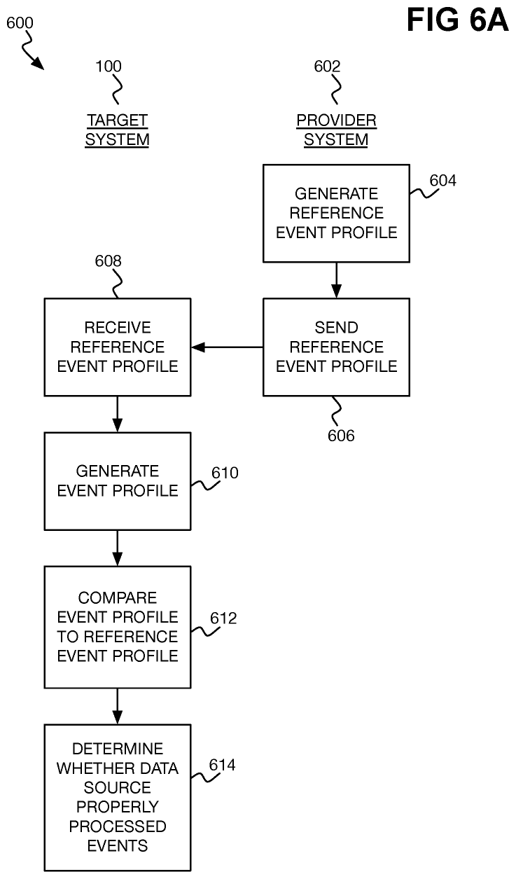

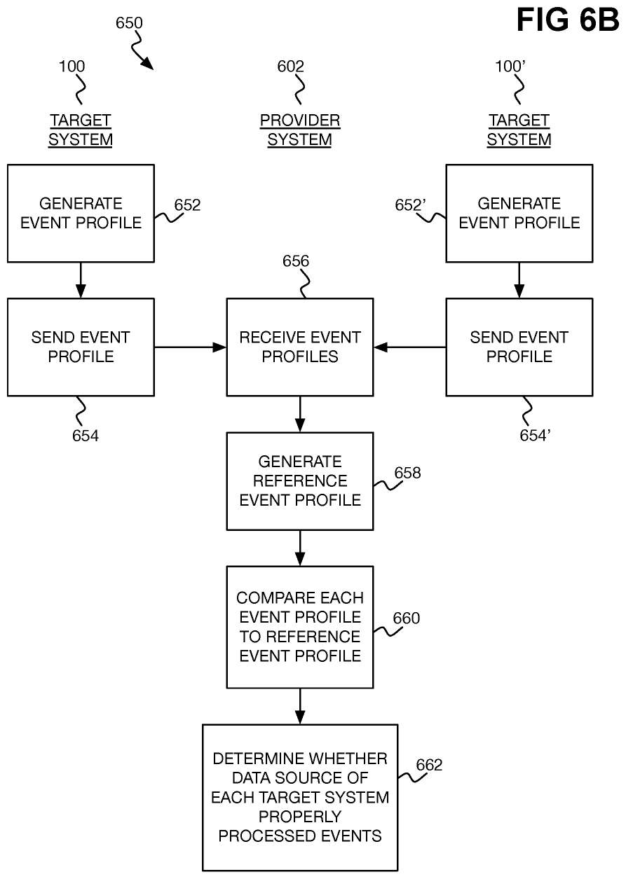

FIG. 6A, by comparison, shows an example method 600 in which a provider system 602 generates the reference event profile 400 to which the target system 100 compares its generated event profile 350 for a data source 102. The provider system 602 is a computing system of the provider (e.g., the developer) of the content 110 or of both the content and the data source 102. The reference event profile 400 that explicitly denotes the event fields 304 that the content 110 expects to be populated with data for accurate analysis of the processed events 108 can thus be generated at the provider system 602 (604).

The reference event profile 400 is sent from the provider system 602 to the target system 100 (606). Upon receipt of the reference event profile 400 (608), the target system 100 may generate the event profile 350 for a data source 102 from the processed events 108 generated by that data source 102 (610). The target system 100 can then compare the event profile 350 to the reference event profile 400 (612), and on the basis of that comparison determine whether the data source 102 properly processed the raw events 106 when generating the processed events 108 (614).

FIG. 6B shows an example method 650 in which the provider system 602 generates the reference event profile 400′ on the basis of processed events 108 generated by the target system 100 as well as at least one other target system 100′. The target system 100 generates the event profile 350 for a data source 102 that generates processed events 108 for a particular type of content 110 (652), as does each target system 100′ (652′). The event profile 350 generated by the target system 100 and by each target system 100′ is then sent to the provider system 602 (654, 654′).

Upon receipt of the event profile 350 from the target system 100 and each target system 100′ (656), the provider system generates the reference event profile 400′ (658). For each event field 304, the corresponding reference percentage 402′ is equal to the average (or other aggregated metric) of the percentage 352 of the event profile 350 received from target system 100 and each target system 100′. The reference event profile 400′ implicitly denotes the event fields 304 that the content 110 uses when analyzing the processed events 108, and takes into consideration the processed events 108 generated at the target system 100 as well as at each target system 100′.

As depicted in the figure, the provider system 602 can then compare the event profile 350 received from the target system 100 and each target system 100′ to the reference event profile 400′ (660). The provider system 602 can therefore determine whether the data source 102 of the target system 100 and each target system 100′ properly processed the raw events 106 when generating the processed events 108 (662). In this example, then, the provider system 602 generates the reference event profile 400′, leveraging an event profile 350 received from the target system 100 and each target system 100′ to increase the accuracy of the reference event profile 400′ in implicitly denoting the event fields 304 that the content 110 expects to be populated.

In another implementation, the target system 100 and each target system 100′ may instead generate a corresponding reference event profile 400′ corresponding to multiple data sources 102 and send it to the provider system 602. The provider system 602 can then generate a composite reference event profile 400′ by averaging (or calculating another aggregate metric of) the reference percentage 402′ of each reference event profile 400′ received from the target system 100 and each target system 100. The provider system 602 may send the composite reference event profile 400′ to the target system 100 and each target system 100′, which can each generate an event profile 350 for a particular data source 102 to compare to the composite reference event profile 400′.

Furthermore, in still another implementation, rather than generating the same reference event profile 400′ from the event profiles 350 sent from all the target systems 100 and 100′, the provider system 602 may generate a reference event profile 400′ for each target system 100 and 100′, using just the event profiles 350 received from the target system 100 or 100′ in question. For example, a given target system 100 or 100′ may send multiple event profiles 350 to the provider system 602. The provider system 602 then generates a reference event profile 400′ from these event profiles 350 (and not from the event profiles 350 received from other target systems 100 and 100′), and compares each event profile 350 received from the given target system 100 or 100′ to that reference profile 400′. That is, multiple reference event profiles 400′ are generated-one for each target system 100 and 100′—instead of a referenced event profile 400′ for all the target systems 100 and 100′.

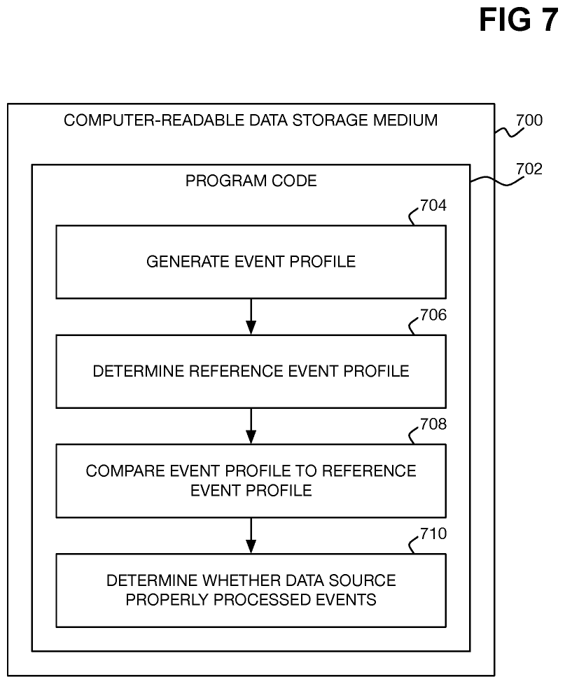

FIG. 7 shows an example non-transitory computer-readable data storage medium 700, such as a memory, storing program code 702 executable by a processor at the target system 100 to perform processing. The processing includes generating an event profile 350 corresponding to a data source 102 at the target system 100 (704). The event profile 350 includes, for each of a number of event fields 304, the percentage of the processed events 108 generated by the data source 102 processing raw events 106 that include data in the event field 304.

The processing includes determining a reference event profile 400 or 400′ that include a reference percentage 402 or 402′ for each event field 304 (706). For example, the target system 100 may generate the reference event profile 400′ itself, or may receive the reference event profile 400 or 400′ from a provider system 602. The processing includes comparing the event profile 350 to the reference event profile 400 or 400′ (708), and determining whether the data source 102 properly processed the raw events 106 based on comparison of the event profile 350 to the reference event profile 400 or 400′ (710).

As noted in response to determining that the data source 102 has not properly generated the processed events 108 from the raw events 106, the target system 100 may be reconfigured in various ways so that it properly converts raw events 106 into processed events 108 in the future. Other actions may also be performed. For example, the results of the comparison of the event profile 350 to the reference event profile 400 or 400′ may trigger an alert to inform an analyst, administrator or other user. As another example, a graphical user interface “dashboard” may be populated with the comparison results, or be included in a report. In these respects, attention is therefore brought to potential data quality issues related to the data sources 102 not properly generating the processed events 108.

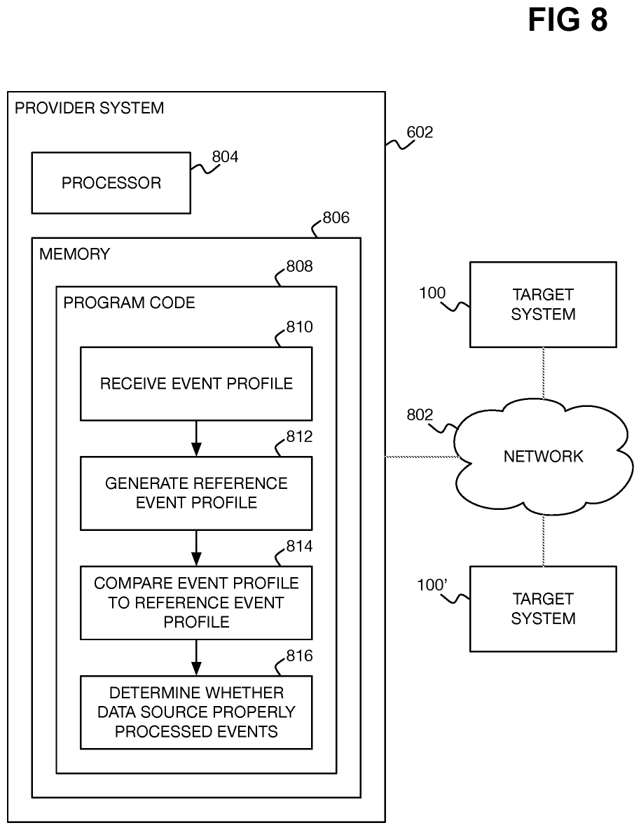

FIG. 8 show an example provider system 602 communicatively connected to the target system 100 and a target system 100′ over a network 802. The network 802 may be or include the Internet, for example. The provider system 602 includes a processor 804 and a memory 806 storing program code 808 executable by the processor 804 to perform processing. The processing includes receiving, from each target system 100 and 100′, an event profile 350 corresponding to a data source 102 at the target system 100 or 100′ in question (810). Each received event profile 350 includes, for each of a number of event fields 304, a percentage of the processed events 108 generated by the data source 102 in question that include data in the event field 304. In another implementation, for a given time period the raw counts of the processed events 108 that include data in each event field 304, as well as the total number of processed events 108 in that given time period, may instead be received by the processor 804, such that the processor 804 calculates the percentage itself.

The processing includes generating a reference event profile 400 or 400′ (812). In the case of the reference event profile 400′, the reference event profile 400′ can be generated from the event profile 350 received from each target system 100 and 100′. The reference event profile 400 or 400′ includes, for each event field 304, a reference percentage. The processing includes comparing the event profile 350 received from each target system 100 and 100′ to the reference event profile 400 or 400′ (814), and determining whether the data source 102 of each target system 100 and 100′ properly processed the raw events 106 based on the comparison (816).

Techniques have been described for determining whether a data source 102 at a target system 100 properly processed raw events 106 received from devices 104 when generating processed events 108 that content 110 analyzes to identify whether the target system 100 is anomalous. That is, the techniques can determine whether the data source 102 populated the processed events 108 with data in event fields 304 that the content 110 expects to be populated so that the content 110 can accurately analyze the processed events 108. As a result, a remedial action can be performed, such as reconfiguring the target system 100, if the data source 102 is not properly processing the raw events 106, to ensure future analysis accuracy of the content 110.

We claim:

1. A method comprising:
determining, by a processor, an event profile corresponding to a data source at a target system, the event profile comprising, for each of a plurality of event fields, a percentage of a plurality of events that after processing by the data source include data in the event field;
determining, by the processor, a reference event profile comprising, for each of the event fields, a reference percentage;
comparing, by the processor, the event profile to the reference event profile; and
determining, by the processor, whether the data source properly processed the events based on comparison of the event profile to the reference event profile.

2. The method of claim 1, further comprising:
in response to determining that the data source did not properly process the events, reconfiguring the target system so that the data source properly processes future events.

3. The method of claim 1, wherein reconfiguring the target system comprises:
updating the data source to a newer version of the data source.

4. The method of claim 1, wherein the data source comprises a connector that receives the events from one or more devices at the target system and processes the events by normalizing the events over the plurality of event fields.

5. The method of claim 1, wherein the reference event profile corresponds to a content that analyzes the events to identify an anomaly at the target system,
wherein, for each event field, the reference percentage of the reference event profile is 100% if the content expects the events to include a value for the event field and 0% if the content does not expect the events to include any value for the event field,
and wherein the comparison of the event profile to the reference event profile indicates whether the data source properly processed the events for accurate analysis by the content.

6. The method of claim 1, wherein the data source is a first data source and the events are first events,
wherein the reference event profile corresponds to a plurality of second data sources of a same data source type as the first data source,
wherein, for each event field, the reference percentage of the reference event profile is based on a percentage of a plurality of second events that after processing by the second data sources include data in the event field,
and wherein the comparison of the event profile to the reference event profile indicates whether the first data source properly processed the first events in comparison to how the second data sources processed the second events.

7. The method of claim 1, wherein the event profile and the reference event profile each have a bit vector having a plurality of bits respectively corresponding to the plurality of events fields,
wherein, for each event field, the bit of the bit vector of the event profile is set to one if the percentage of the events that after processing by the data source included data in the event field is greater than a threshold, and is set to zero if the percentage of the events that after processing by the data source included data in the event field in the event field is less than the threshold,
wherein, for each event field, the bit of the bit vector of the reference event profile is set to one if the reference percentage is greater than the threshold, and is set to zero if the reference percentage is less than the threshold,
wherein comparing the event profile to the reference event profile comprises calculating a similarity measure between the bit vector of the event profile and the bit vector of the reference event profile,
and wherein the comparison of the event profile to the reference event profile is a presence level-comparison between the event profile and the reference event profile as to the event fields.

8. The method of claim 1, wherein the event profile and the reference event profile each have a vector having a plurality of values respectively corresponding to the plurality of event fields,
wherein, for each event field, the value of the vector of the event profile is set to the percentage of the events that after processing by the data source included data in the event field,
wherein, for each event field, the value of the vector of the reference event profile is set to the reference percentage,
wherein comparing the event profile to the reference event profile comprises calculating a similarity measure between the vector of the event profile and the vector of the reference event profile,
and wherein the comparison of the event profile to the reference event profile is an aggregate level-comparison between the event profile and the reference event profile as to the event fields.

9. The method of claim 1, wherein the event profile has a distribution over time as to the percentage of the events that after processing by the data source included data in each event field,
wherein the reference event profile has a reference distribution over time as to the reference percentage for each event field,
wherein comparing the event profile to the reference event profile comprises calculating a similarity measure between the distribution of the event profile and the reference distribution of the reference event profile,
and wherein the comparison of the event profile to the reference event profile is a distribution level-comparison between the event profile and the reference event profile as to the event fields.

10. A non-transitory computer-readable data storage medium storing program code executable by a processor at a target system to perform processing comprising:
generating an event profile corresponding to a data source at the target system, the event profile comprising, for each of a plurality of event fields, a percentage of a plurality of events that after processing by the data source included data in the event field;
determining a reference event profile comprising, for each of the event fields, a reference percentage;
comparing the event profile to the reference event profile; and
determining whether the data source properly processed the events based on comparison of the event profile to the reference event profile.

11. The non-transitory computer-readable data storage medium of claim 10, wherein the processing further comprises:
in response to determining that the data source did not properly process the events, reconfiguring the target system so that the data source properly processes future events.

12. The non-transitory computer-readable data storage medium of claim 10, wherein the data source comprises a connector that receives the events from one or more devices at the target system and processes the events by normalizing the events over the plurality of event fields.

13. The non-transitory computer-readable data storage medium of claim 10, wherein the reference event profile corresponds to a content that analyzes the events to identify an anomaly at the target system,
wherein determining the reference event profile comprises receiving the reference event profile from a content provider system,
wherein, for each event field, the reference percentage of the reference event profile is 100% if the content expects the events to include a value for the event field and 0% if the content does not expect the events to include any value for the event field,
and wherein the comparison of the event profile to the reference event profile indicates whether the data source properly processed the events for accurate analysis by the content.

14. The non-transitory computer-readable data storage medium of claim 10, wherein the data source is a first data source and the events are first events,
wherein the reference event profile corresponds to a plurality of second data sources at the target system that are of a same data source type as the first data source,
wherein determining the reference event profile comprises generating the reference event profile,
wherein, for each event field, the reference percentage of the reference event profile is based on a percentage of a plurality of second events that after processing by the second data sources include data in the event field,
and wherein the comparison of the event profile to the reference event profile indicates whether the first data source properly processed the first events in comparison to how the second data sources processed the second events.

15. A provider system comprising:
a processor; and
a memory storing program code executable by the processor to perform processing comprising:
receiving, from a target system, an event profile corresponding to a data source at the target system, the event profile comprising, for each of a plurality of event fields, a percentage of a plurality of events that after processing by the data source include data in the event field;
generating a reference event profile comprising, for each of the event fields, a reference percentage;
comparing the event profile to the reference event profile; and
determining whether the data source properly processed the events based on comparison of the event profile to the reference event profile.

16. The provider system of claim 15, wherein the processing further comprises:
in response to determining that the data source did not properly process the events, causing the target system to be reconfigured so that the data source properly processes future events.

17. The provider system of claim 16, wherein causing the target system to be reconfigured comprises:
causing the data source at the target system to be updated to a newer version of the data source.

18. The provider system of claim 15, wherein the data source comprises a connector that receives the events from one or more devices at the target system and processes the events by normalizing the events over the plurality of event fields.

19. The provider system of claim 15, wherein the reference event profile corresponds to a content that analyzes the events to identify an anomaly at the target system,
wherein, for each event field, the reference percentage of the reference event profile is 100% if the content expects the events to include a value for the event field and 0% if the content does not expect the events to include any value for the event field,
and wherein the comparison of the event profile to the reference event profile indicates whether the data source properly processed the events for accurate analysis by the content.

20. The provider system of claim 15, wherein the data source is a first data source, the events are first events, and the event profile is a first event profile,
wherein the reference event profile corresponds to a plurality of second data sources of a same data source type as the first data source,
wherein generating the reference event profile comprises receiving second event profiles corresponding to the second data sources, the reference event profile generated from the second event profiles,
wherein, for each event field, the reference percentage of the reference event profile is based on a percentage a plurality of second events that after processing by the second data sources include data in the event field,
and wherein the comparison of the event profile to the reference event profile indicates whether the first data source properly processed the first events in comparison to how the second data sources processed the second events.
